(19) United States
(12) Patent Application Publication
(10) Pub. No.: US 2004/0075186 A1
(43) Pub. Date: Apr. 22, 2004

(54) Functional organic powders, methods for production and use thereof

(76) Inventors: Wolfgang Bremser, Munster (DE); Ute Stockbrink, Emsdetten (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/474,830

(22) PCT Filed: May 24, 2002
(86) PCT No.: PCT/EP02/05701

(30) Foreign Application Priority Data
Jun. 1, 2001 (DE) 101 26 650.2

(51) Int. Cl. B02C 1/00

(52) U.S. Cl. 264/140

(57) ABSTRACT

The use of a copolymer (A) preparable by free-radical polymerization of

a) at least one olefinically unsaturated monomer and

b) at least one olefinically unsaturated monomer different than the olefinically unsaturated monomer (a) and of the general formula I

R¹R²C═CR³R⁴ (I)

in which the radicals R¹, R² R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals;

in an aqueous or organic medium for preparing functional organic powders, especially fillers for coating materials, adhesives, and sealing compounds of all kinds.

The present invention relates to the innovative use of a copolymer and its aqueous dispersion to prepare novel functional organic powders. The present invention also relates to novel functional organic powders. The present invention additionally relates to a novel process for preparing functional organic powders. The present invention relates not least to the use of these functional organic powders as fillers in coating materials, adhesives, and sealing compounds.

Pulverulent organic fillers made of textile, cellulose, polyethylene, polypropylene, polyamide, polyacrylonitrile or polyester have been known for a long time (cf. Römpp Lexikon Lacke und Druckfarben, Georg Thieme Verlag, Stuttgart, N.Y., 1998, “fillers”, pages 250 to 252). A disadvantage is that these organic fillers have largely inert surfaces, whose interaction with the matrices surrounding them is in many cases minimal. In certain circumstances, this may have deleterious consequences for the mechanical strength, permeability, and chemical stability of filled coatings, adhesive films, and seals. Although functionalizing the organic fillers is an option, it represents an additional expense which may make the functionalized fillers uneconomic, particularly for use in mass products.

The use of dispersions of copolymers preparable by single-stage or multistage free-radical copolymerization in aqueous media of

a) at least one olefinically unsaturated monomer and

b) at least one olefinically unsaturated monomer different than the olefinically unsaturated monomer (a) and of the general formula I

R¹R²C═CR³R⁴ (I)

in which the radicals R¹, R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals,

as binders in coating materials, especially aqueous basecoat materials (cf. the German patent application DE 199 30 665 A1), primer-surfacers and antistonechip primers (cf. the German patent application DE 199 30 067 A1), and clearcoat materials (cf. the German patent application DE 199 30 664 A1) is known. Their use for preparing functional organic fillers is not described in the patent applications.

The German patent application DE 100 18 078.1, unpublished at the priority date of the present specification, describes the use of the aforementioned copolymers and their dispersions to prepare molding compounds, and processes for producing moldings. The molding compounds and moldings are formed by the reaction of the dispersions of the copolymers with amino resins. The use of the copolymers to prepare functional organic powders is not described in the German patent application.

It is an object of the invention to find a further novel use for the aforementioned copolymers of the prior art.

A further object of the present invention is to find novel functional organic powders which are easy to prepare and can be functionalized diversely, are stable to organic solvents, and can be used very widely.

Another object of the present invention is to find novel functional organic fillers which likewise have this profile of properties.

A further object of the present invention is to find a novel process for preparing functional organic powders which is easy to conduct and with which the functional organic powders may be diversely functionalized in order that they may be used very widely, especially as fillers.

It is an object of the present invention not least to find novel coating materials, adhesives, and sealing compounds having improved performance properties and comprising functional organic fillers.

The invention accordingly provides for the innovative use of a copolymer (A) preparable by single-stage or multistage free-radical polymerization of

a) at least one olefinically unsaturated monomer and

b) at least one olefinically unsaturated monomer different than the olefinically unsaturated monomer (a) and of the general formula I

R¹R²C═CR³R⁴ (I)

in which the radicals R¹, R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals

in an aqueous or organic medium for preparing functional organic powders.

In the text below, the novel use of the copolymer (A) is referred to as “use in accordance with the invention”.

The invention also provides the novel functional organic powders preparable

(I) by reacting

(A) at least one primary and/or secondary aqueous dispersion of at least one copolymer (A) preparable by single-stage or multistage free-radical copolymerization in an aqueous or organic medium of

a) at least one olefinically unsaturated monomer and

b) at least one olefinically unsaturated monomer different than the olefinically unsaturated monomer (a) and of the general formula I

R¹R²C═CR³R⁴ (I)

in which the radicals R¹ , R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals

(B) with at least one amino resin,

and

(II) by subsequently comminuting the resultant solid.

In the text below, the novel functional organic powders are referred to as “powders of the invention”.

The invention additionally provides the novel process for preparing organic functional powders which involves

(I) preparing a reactive composition of matter comprising

(A) the aqueous dispersion of at least one copolymer (A) preparable by free-radical copolymerization in an aqueous or organic medium of

(a) at least one olefinically unsaturated monomer having at least one functional group which is reactive toward amino resin, and

(b) at least one olefinically unsaturated monomer different than the olefinically unsaturated monomer (a) and of the general formula I

R¹R²C═CR³R⁴ (I)

in which the radicals R¹, R², R³ and R⁴ in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals

and

(B) at least one amino resin,

(II) curing the reactive composition of matter to give a solid in an appropriate mold,

(III) separating mold from solid, and

(IV) comminuting the solid.

In the text below, the novel process for preparing functional organic powders is referred to as the “process of the invention”.

The invention provides not least for the novel use of the powders of the invention as fillers.

Further uses and subject matter of the invention will emerge from the description.

In the light of the prior art it was surprising and unforeseeable to the skilled worker that the object on which the present invention was based could be solved with the aid of the use in accordance with the invention and of the powders and process of the invention.

This was all the more surprising since heat-curable substances, such as heat-curable coating materials based on amino resins, for example, must usually be cured at temperatures above 100° C. in order to provide fully cured, thermoset coatings within a short process time. In the present case, however, it was surprisingly possible to produce thermoset, insoluble solids even at room temperature. These thermoset solids could be comminuted and pulverized without problems to give the powders of the invention.

Since it was possible to vary the material composition and functional-group functionalization of the copolymers (A) to a surprisingly broad extent, the results were powders of the invention which have a likewise broad applicability.

The functionalization of the powders of the invention also made it possible to effect surprisingly broad physical modification of their surface in order to adapt their performance properties to specific matrices.

In particular, in the context of their use as fillers, it was possible by functionalizing the copolymers (A) for use in accordance with the invention and by selecting appropriate additives, especially pigments, to adapt them outstandingly to a very wide variety of physical and chemical matrices, especially to coating materials, adhesives, and sealing compounds of all kinds and also to the coatings, adhesive films, and seals produced from these compositions.

The coating materials, adhesives, and sealing compounds of the invention in question were therefore particularly stable on storage and in transit and also showed no tendency toward separation, especially of the fillers of the invention, under extreme and/or frequently changing climatic conditions.

The fillers of the invention were therefore suitable for use not only for improving mechanical properties and the energy-dissipative properties of the coatings, adhesive films, and seals of the invention but also, for example, for imparting color and/or effect.

In the context of the present invention, the quality of being “functional” means that the surface of the powders of the invention carries functional groups which give the surface of the powders of the invention certain properties, such as hydrophilicity or hydrophobicity, acidity or basicity, or an increased reactivity.

The first essential constituent of the powders of the invention is at least one copolymer (A). In accordance with the invention, the copolymer (A) is prepared by free-radical (co)polymerization of at least one olefinically unsaturated monomer (a) and at least one olefinically unsaturated monomer (b) different than the monomer (a).

Suitable monomers (a) include a very wide variety of olefinically unsaturated monomers. In accordance with the invention it is of advantage to use at least one monomer (a) having at least one, and in particular one, functional group that is reactive toward amino resin. Examples of suitable functional groups reactive toward amino resin are thio, hydroxyl, amino, N-methylolamino, N-alkoxymethylamino, imino, carbamate and/or allophanate groups, especially hydroxyl groups.

Examples of suitable monomers (a) are the monomers (a1) such as

hydroxyalkyl esters of acrylic acid, methacrylic acid or another alpha,beta-olefinically unsaturated carboxylic acid which are derived from an alkylene glycol which is esterified with the acid or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid in which the hydroxyalkyl group contains up to 20 carbon atoms, such as 2-hydroxyethyl, 2-hydroxypropyl, 3-hydroxypropyl, 3-hydroxybutyl and 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; reaction products of cyclic esters, such as epsilon-caprolactone, for example, and these hydroxyalkyl or hydroxycycloalkyl esters;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid having 5 to 18 carbon atoms per molecule, in particular of a Versatic® acid, or instead of the reaction product an equivalent amount of acrylic and/or methacrylic acid, which is then reacted during or after the polymerization reaction with the glycidyl ester of an alpha-branched monocarboxylic acid having 5 to 18 carbon atoms per molecule, in particular of a Versatic® acid;

aminoethyl acrylate, aminoethyl methacrylate, allyl amine or N-methyliminoethyl acrylate;

N,N-di(methoxymethyl)aminoethyl acrylate or meth-acrylate or N,N-di(butoxymethyl)aminopropyl acrylate or methacrylate;

hydroxyl-containing, acryloyloxysilane-containing vinyl monomers, preparable by reacting hydroxyfunctional silanes with epichlorohydrin and then reacting the reaction product with (meth)acrylic acid and/or hydroxyalkyl and/or hydroxycycloalkyl esters of (meth)acrylic acid (cf. monomers a3);

N-methylol- and N-methoxyalkyl-substituted (meth)acrylamides, such as N-methyl-, N-methylol-, N,N-dimethylol-, N-methoxymethyl-, N,N-di(methoxymethyl)-, N-ethoxymethyl- and/or N,N-di(ethoxymethyl)-(meth)acrylamide; and/or

acryloyloxy- or methacryloyloxyethyl, -propyl or -butyl carbamate or allophanate; further examples of suitable monomers containing carbamate groups are described in the patents U.S. Pat. No. 3,479,328, U.S. Pat. No. 3,674,838, U.S. Pat. No. 4,126,747, U.S. Pat. No. 4,279,833, and U.S. Pat. No. 4,340,497.

Higher-functional monomers (a1) are used generally in minor amounts. In the context of the present invention, minor amounts of higher-functional monomers are those amounts which do not lead to crosslinking or gelling of the copolymers, unless the deliberate intention is to produce crosslinked polymeric microparticles.

The monomers (a1) may be used as the sole monomers. In accordance with the invention, however, it is of advantage to use further olefinically unsaturated monomers (a) as well in order to vary in an advantageous manner the profile of properties of the copolymers (A) for use in accordance with the invention and to tailor it to the particular intended use of the powders of the invention.

Examples of suitable further monomers (a) are

(a2) (meth)acrylic esters which are substantially free of acid groups, such as (meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tert-butylcyclohexyl (meth)acrylate; (meth)acrylic oxaalkyl esters or oxacycloalkyl esters, such as ethyl triglycol (meth)acrylate and methoxyoligoglycol (meth)acrylate having a molecular weight Mn of preferably 550, or other ethoxylated and/or propoxylated, hydroxyl-free (meth)acrylic acid derivatives. They may include, in minor amounts, higher-functional (meth)acrylic alkyl or cycloalkyl esters such as ethylene glycol, propylene glycol, diethylene glycol, dipropylene glycol, butylene glycol, 1,5-pentanediol, 1,6-hexanediol, octahydro-4,7-methano-1H-indene-dimethanol or cyclohexane-1,2-, -1,3- or -1,4-diol di(meth)acrylate; trimethylolpropane di- or tri(meth)acrylate; or pentaerythritol di-, tri- or tetra(meth)acrylate. With regard to the higher-functional monomers (a2), the comments made above apply.

(a3) Monomers which carry per molecule at least one acid group that can be converted into the corresponding acid anion group, such as acrylic acid, beta-carboxyethyl acrylate, methacrylic acid, ethacrylic acid, crotonic acid, maleic acid, fumaric acid, itaconic acid, alpha-methylvinylbenzoic acid (all isomers), or vinylbenzoic acid (all isomers); olefinically unsaturated sulfonic or phosphonic acids or their partial esters, such as p-vinylbenzenesulfonic acid; or mono(meth)acryloyloxyethyl maleate, succinate or phthalate.

(a4) Vinyl esters of alpha-branched monocarboxylic acids having 5 to 18 carbon atoms in the molecule. The branched monocarboxylic acids can be obtained by reacting formic acid or carbon monoxide and water with olefins in the presence of a liquid, strongly acidic catalyst; the olefins may be cracking products of paraffinic hydrocarbons, such as petroleum fractions, and may comprise both branched and straight-chain acyclic and/or cycloaliphatic olefins. The reaction of such olefins with formic acid, or with carbon monoxide and water, produces a mixture of carboxylic acids in which the carboxyl groups are located predominantly on a quaternary carbon atom. Other olefinic starting materials are, for example, propylene trimer, propylene tetramer, and diisobutylene. Alternatively, the vinyl esters (a4) may be prepared in a manner known per se from the acids, for example, by reacting the acid with acetylene. Particular preference is given, owing to their ready availability, to the use of vinyl esters of saturated aliphatic monocarboxylic acids having 9 to 11 carbon atoms that are branched on the alpha carbon atom, but especially Versatic® acids.

(a5) Cyclic and/or acyclic olefins such as ethylene, propylene, 1-butene, 1-pentene, 1-hexene, cyclohexene, cyclopentene, norbornene, butadiene, isoprene, cyclopentadiene and/or dicyclopenta-diene.

(a6) (Meth)acrylamides such as (meth)acrylamide, N-methyl-, N,N-dimethyl-, N-ethyl-, N,N-diethyl-, N-propyl-, N,N-dipropyl-, N-butyl-, N,N-dibutyl-, N-cyclohexyl- and/or N,N-cyclohexyl-methyl-(meth)acrylamide.

(a7) Monomers containing epoxide groups, such as the glycidyl ester of acrylic acid, methacrylic acid, ethacrylic acid, crotonic acid, maleic acid, fumaric acid and/or itaconic acid, or allyl glycidyl ether.

(a8) Vinylaromatic hydrocarbons such as styrene, alpha-alkylstyrenes, especially alpha-methyl-styrene and/or vinyltoluene, N,N-diethylamino-styrene (all isomers) and/or N,N-diethylaminoalpha-methyl-styrene (all isomers).

(a9) Nitriles such as acrylonitrile and/or methacrylo-nitrile.

(a10) Vinyl compounds, especially vinyl halides and/or vinylidene dihalides such as vinyl chloride, vinyl fluoride, vinylidene dichloride or vinylidene difluoride; N-vinyl amides such as vinyl-N-methylformamide, N-vinylcaprolactam, 1-vinylimidazole or N-vinylpyrrolidone; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

(a11) Allyl compounds, especially allyl ethers and allyl esters such as allyl methyl, ethyl, propyl or butyl ether or allyl acetate, propionate or butyrate, and/or

(a12) polysiloxane macromonomers which have a number-average molecular weight Mn of from 1000 to 40,000 and contain on average from 0.5 to 2.5 ethylenically unsaturated double bonds per molecule; especially polysiloxane macromonomers having a number-average molecular weight Mn of from 2 000 to 20 000, with particular preference from 2 500 to 10 000, and in particular from 3 000 to 7 000, and containing on average from 0.5 to 2.5, preferably from 0.5 to 1.5, ethylenically unsaturated double bonds per molecule, as are described in DE-A-38 07 571 on pages 5 to 7, in DE-A 37 06 095 in columns 3 to 7, in EP-B-0 358 153 on pages 3 to 6, in U.S. Pat. No. 4,754,014 in columns 5 to 9, in DE-A 44 21 823, or in the international patent application WO 92/22615 on page 12, line 18 to page 18, line 10.

In accordance with the invention, very particular advantages result if the monomers (a2) and/or (a3) are used as additional monomers (a).

In accordance with the invention, compounds of the general formula I are used as monomers (b).

In the general formula I the radicals R¹, R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals.

Examples of suitable alkyl radicals are methyl, ethyl, propyl, isopropyl, n-butyl, isobutyl, tert-butyl, amyl, hexyl or 2-ethylhexyl.

Examples of suitable cycloalkyl radicals are cyclobutyl, cyclopentyl or cyclohexyl.

Examples of suitable alkylcycloalkyl radicals are methylenecyclohexane, ethylenecyclohexane or propane-1,3-diylcyclohexane.

Examples of suitable cycloalkylalkyl radicals are 2-, 3- or 4-methyl-, -ethyl-, -propyl- or -butylcyclohex-1-yl.

Examples of suitable aryl radicals are phenyl, naphthyl or biphenylyl, preferably phenyl and naphthyl, and especially phenyl.

Examples of suitable alkylaryl radicals are benzyl or ethylene- or propane-1,3-diylbenzene.

Examples of suitable cycloalkylaryl radicals are 2-, 3- or 4-phenylcyclohex-1-yl.

Examples of suitable arylalkyl radicals are 2-, 3- or 4-methyl-, -ethyl-, -propyl- or -butylphen-1-yl.

Examples of suitable arylcycloalkyl radicals are 2-, 3- or 4-cyclohexylphen-1-yl.

The above-described radicals R¹, R², R³ and R⁴ may be substituted. For this purpose, electron withdrawing or electron donating atoms or organic radicals may be used.

Examples of suitable substituents are halogen atoms, especially chlorine and fluorine, nitrile groups, nitro groups, partially or fully halogenated, especially chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

Examples of monomers (b) used with particular preference in accordance with the invention are diphenylethylene, dinaphthaleneethylene, cis- or trans-stilbene, vinylidenebis(4-N,N-dimethylaminobenzene), vinylidenebis(4-aminobenzene) or vinylidenebis(4-nitro-benzene).

In accordance with the invention, the monomers (b) may be used individually or as a mixture of at least two monomers (b).

In terms of the reaction regime and of the properties of the resultant copolymers (A), especially of the acrylate copolymers (A), diphenylethylene is of very particular advantage and is therefore used with very particular preference in accordance with the invention.

The monomers (a) and (b) for use in accordance with the invention are reacted with one another in the presence of at least one free-radical initiator to give the copolymer (A). Examples of initiators which may be used include: dialkyl peroxides, such as di-tert-butyl peroxide or dicumyl peroxide; hydroperoxides, such as cumene hydroperoxide or tert-butyl hydroperoxide; per esters, such as tert-butyl perbenzoate, tert-butyl perpivalate, tert-butyl per-3,5,5-trimethylhexanoate or tert-butyl per-2-ethylhexanoate; potassium, sodium or ammonium peroxodisulfate; azo dinitriles such as azobisisobutyronitrile; C—C-cleaving initiators such as benzpinacol silyl ethers; or a combination of a nonoxidizing initiator with hydrogen peroxide.

It is preferred to add comparatively large amounts of free-radical initiator, the proportion of the initiator in the reaction mixture, based in each case on the overall amount of the monomers (a) and of the initiator, being with particular preference from 0.5 to 50% by weight, with very particular preference from 1 to 20% by weight, and in particular 2 to 15% by weight.

The weight ratio of initiator to the monomers (b) is preferably from 4:1 to 1:4, with particular preference from 3:1 to 1:3, and in particular from 2:1 to 1:2. Further advantages result if the initiator is used in an excess within the stated limits.

Preferably, the free-radical copolymerization is conducted in customary and known apparatuses, especially stirred vessels or Taylor reactors, the Taylor reactors being designed such that the conditions of Taylor flow are met over the entire reactor length, even if the kinematic viscosity of the reaction medium alters greatly, and in particular increases, owing to the copolymerization.

The two-stage or multistage free-radical copolymerization or block copolymerization is conducted in an aqueous or organic medium.

Where the copolymerization is conducted in an organic medium, the resulting organic solution or dispersion of the copolymer or block copolymer or copolymers (A) is dispersed in an aqueous medium to give a secondary dispersion (A). If desired, the organic solvents present therein are removed by distillation.

Where the copolymerization is conducted in an aqueous medium, aqueous primary dispersions (A) are formed which may be used as they are, directly, for the preparation of the powders of the invention.

Preferably, the copolymerization is conducted in an aqueous medium.

The aqueous medium comprises essentially water. Said aqueous medium may comprise in minor amounts the additives (C) described below and/or other dissolved solid, liquid or gaseous organic and/or inorganic substances of low and/or high molecular mass, especially surface-active substances, provided these do not adversely affect, or even inhibit, the copolymerization. In the context of the present invention, the term “minor amount” means an amount which does not overturn the aqueous nature of the aqueous medium.

Alternatively, the aqueous medium may comprise just water.

Preferably, the copolymerization is conducted in the presence of at least one base. Particular preference is given to low molecular mass bases such as sodium hydroxide, potassium hydroxide, ammonia, diethanolamine, triethanolamine, mono-, di- and triethylamine, and/or dimethylethanolamine, especially ammonia and/or di- and/or triethanolamine.

The copolymerization is advantageously conducted at temperatures above room temperature and below the lowest decomposition temperature of the particular monomers used, with the chosen temperature range being preferably from 10 to 150° C., with very particular preference from 70 to 120° C., and in particular from 80 to 110° C.

When using particularly volatile monomers (a) and/or (b) the copolymerization may also be conducted under pressure, preferably under from 1.5 to 3000 bar, with particular preference from 5 to 1500 bar, and in particular from 10 to 1000 bar.

In terms of the molecular weight distibution, the copolymer (A) is not subject to any restrictions. Advantageously, however, the copolymerization is conducted so as to give a molecular weight distribution Mw/Mn, measured by gel permeation chromatography using polystyrene as standard, of ≦4, with particular preference ≦2, and in particular ≦1.5, and in certain cases even ≦1.3. The molecular weights of the copolymers (A) can be controlled within wide limits by the choice of the ratio of monomer (a) to monomer (b) to free-radical initiator. In this context, the molecular weight is determined in particular by the amount of monomer (b), specifically such that the higher the proportion of monomer (b), the lower the resulting molecular weight.

The copolymer (A) resulting from the copolymerization is produced as a mixture with the aqueous medium, generally in the form of a dispersion (A). Its solids content may vary very widely; it is preferably from 5 to 60, more preferably from 10 to 55, with particular preference from 15 to 50, with very particular preference from 20 to 45, and in particular from 25 to 40, % by weight, based in each case on the dispersion (A).

The dispersion (A) can be used directly to produce the powders of the invention. In accordance with the invention, however, it is of advantage to use the dispersion (A) and/or the copolymer (A) present therein as a macroinitiator for the further reaction with at least one further monomer (a) in at least one further, and in particular one further stage, i.e., a second stage (ii), the (block) copolymerization being conducted preferably in the absence of a free-radical initiator.

The further reaction in accordance with the stage (ii) is preferably conducted under the customary conditions for a free-radical polymerization, where appropriate additives (C) may be present. The stages (i) and (ii) may be conducted separately from one another both spatially and temporally. Furthermore, however, the stages (i) and (ii) may also be conducted in succession in one reactor. For this purpose, first of all the monomer (b) is reacted fully or partly with at least one monomer (a), depending on the desired application and properties, after which at least one further monomer (a) is added and the mixture is subjected to free-radical polymerization. In another embodiment, at least two monomers (a) are used from the start, the monomer (b) reacting first of all with one of the at least two monomers (a) and then the resultant reaction product (A) reacting, above a certain molecular weight, with the further monomer (a) as well.

Depending on the reaction regime, it is possible in accordance with the invention to prepare endgroup-functionalized polymers, block or multiblock and gradient (co)polymers, star polymers, graft copolymers, and branched (co)polymers as copolymers (A).

Copolymers (A) prepared in the multistage procedure described above provide particularly advantageous powders of the invention, and so are used with particular preference in accordance with the invention.

The solids content of the dispersions (A) prepared in a multistage procedure may also vary very widely; it is preferably from 10 to 70, more preferably from 15 to 65, with particular preference from 20 to 60, with very particular preference from 25 to 55, and in particular from 30 to 50, % by weight, based in each case on the dispersion (A).

The amount of the copolymers (A), prepared in a single-stage or a multistage procedure, in the powders of the invention may likewise vary very widely and is guided by the requirements of the individual case. The amount is preferably from 5 to 60, more preferably from 10 to 55, with particular preference from 15 to 50, with very particular preference from 20 to 45, and in particular from 25 to 40, % by weight, based in each case on the powder of the invention.

The second essential constituent of the powders of the invention is at least one amino resin (B). In this case it is possible to use any amino resin suitable for heat-curable coating materials, or a mixture of such amino resins. In particular it is possible to use melamine resins, guanamine resins, benzoguanamine resins, or urea resins, especially melamine resins. For further details reference is made to Römpp Lexikon Lacke und Druckfarben, Georg Thieme Verlag, 1998, page 29, “amino resins”, and the textbook “Lackadditive” [Additives for coatings] by Johan Bieleman, Wiley-VCH, Weinheim, New York, 1998, pages 242 ff., or the book “Paints, Coatings and Solvents”, second, completely revised edition, eds. D. Stoye and W. Freitag, Wiley-VCH, Weinheim, New York, 1998, pages 80 ff. Further suitable amino resins are the customary and known amino resins some of whose methylol and/or methoxymethyl groups have been defunctionalized by means of carbamate or allophanate groups. Crosslinking agents of this kind are described in the patents U.S. Pat. No. 4,710,542 and EP-B1-0 245 700 and the article by B. Singh and coworkers, “Carbamylmethylated Melamines, Novel Crosslinkers for the Coatings Industry” in Advanced Organic Coatings Science and Technology Series, 1991, volume 13, pages 193 to 207.

The amount of amino resins (B) in the powders of the invention may also vary very widely. It is guided in particular by the number and reactivity of the functional groups reactive toward amino resin that are present in the copolymers (A). The amount is preferably from 1 to 40, more preferably from 2 to 35, with particular preference from 3 to 30, with very particular preference from 4 to 25, and in particular from 5 to 20, % by weight, based in each case on the powder of the invention.

Furthermore, the powders of the invention may comprise at least one customary and known additive (C) in the effective amounts which are known and customary in each case.

As additive (C) it is preferred to use at least one pigment (C), which may be added to the dispersions (A) before, during or after, in particular after, the preparation of the copolymers (A).

The pigments (C) are preferably selected from the group consisting of color and/or effect pigments, fluorescent pigments, electrically conductive pigments, and magnetically shielding pigments, metal powders, organic and inorganic, transparent and opaque fillers, and nanoparticles.

The amount of the pigments (C) in the powders of the invention may vary widely. The amount is preferably chosen so that the quantitative ratio of pigments (C) to copolymers (A) (pigment/binder ratio) is from 1:10 to 5:1, more preferably from 1:8 to 4.5:1, with particular preference from 1:6 to 4:1, with very particular preference from 1:4 to 3.5:1, and in particular from 1:2 to 3:1.

Examples of suitable effect pigments are metal flake pigments such as commercial aluminum bronzes, aluminum bronzes chromated in accordance with DE-A1-36 36 183, commercial stainless steel bronzes, and also nonmetallic effect pigments, such as pearlescent pigments and interference pigments, platelet-shaped effect pigments based on iron oxide with a color from pink to brownish red, and liquid-crystalline effect pigments. For further details, refer to Römpp Lexikon Lacke und Druckfarben, Georg Thieme Verlag, 1998, page 176, “Effect pigments” and pages 380 and 381 “Metal oxide-mica pigments” to “metal pigments”, and to the patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A, and U.S. Pat. No. 5,244,649 A.

Examples of suitable inorganic color pigments are white pigments such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow, or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrol pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details, refer to Römpp Lexikon Lacke und Druckfarben, Georg Thieme Verlag, 1998, pages 180 and 181, “iron blue pigments” to “black iron oxide”, pages 451 to 453, “pigments” to “pigment volume concentration”, page 563, “thioindigo pigments”, page 567, “titanium dioxide pigments”, pages 400 and 467, “naturally occurring pigments”, page 459, “polycyclic pigments”, page 52, “azomethine pigments”, “azo pigments”, and page 379, “metal complex pigments”.

Examples of fluorescent pigments (daylight-fluorescent pigments) are bis(azomethine) pigments.

Examples of suitable electrically conductive pigments are titanium dioxide/tin oxide pigments.

Examples of magnetically shielding pigments are pigments based on iron oxides or chromium dioxide.

Examples of suitable metal powders are powders of metals and metal alloys comprising aluminum, zinc, copper, bronze or brass.

Examples of suitable organic and inorganic fillers are chalk, calcium sulfates, barium sulfate, silicates such as talc, mica or kaolin, silicas, oxides such as aluminum hydroxide and magnesium hydroxide, or organic fillers such as plastics powders, especially those of polyamide or polyacrylonitrile. For further details, refer to Römpp Lexikon Lacke und Druckfarben, Georg Thieme Verlag, 1998, pages 250 ff., “fillers”.

Examples of suitable transparent fillers are those based on silica, alumina or zirconium oxide.

Suitable nanoparticles are selected from the group consisting of hydrophilic and hydrophobic, especially hydrophilic, nanoparticles based on silica, alumina, zinc oxide, zirconium oxide, and the polyacids and heteropolyacids of transition metals, preferably of molybdenum and tungsten, having a primary particle size <50 nm, preferably from 5 to 50 nm, in particular from 10 to 30 nm. Preferably, the hydrophilic nanoparticles do not have any flatting effect. Particular preference is given to using nanoparticles based on silica.

Very particular preference is given to using hydrophilic pyrogenic silicas whose agglomerates and aggregates have a catenated structure, and which can be prepared by the flame hydrolysis of silicon tetrachloride in an oxyhydrogen flame. These substances are sold, for example, by Degussa under the brand name Aerosil®. Very particular preference is also given to using precipitated waterglasses, such as nanohectorites, which are sold, for example, by Sudchemie under the brand name Optigel® or by Laporte under the brand name Laponite®.

Instead of the above-described pigments (C) or in addition to them it is also possible for the powders of the invention to include at least one further additive (C).

Examples of suitable further additives (C) are molecularly dispersely soluble dyes, light stabilizers, such as UV absorbers and reversible free-radical scavengers (HALS); antioxidants; low-boiling and high-boiling (“long”) organic solvents; devolatilizers; wetting agents; emulsifiers; slip additives; polymerization inhibitors; crosslinking catalysts; thermolabile free-radical initiators; thermally curable reactive diluents; adhesion promoters, leveling agents; film-forming auxiliaries; Theological aids (thickeners and pseudoplastic sag control agents—SCAs); flame retardants; corrosion inhibitors; free-flow aids; waxes; siccatives; biocides; and/or flatting agents; as described in detail, for example, in the textbook “Lackadditive” by Johan Bieleman, Wiley-VCH, Weinheim, New York, 1998, or in the German patent application DE 199 14 896 A1, column 14 line 26 to column 15 line 46.

Further examples of suitable additives (C) are described in detail in the textbook “Lackadditive” by Johan Bieleman, Wiley-VCH, Weinheim, New York, 1998.

The preparation of the powders of the invention takes place preferably by mixing and homogenizing the dispersions (A) with the amino resins (B) and, if appropriate, the additives (C) in suitable mixing equipment such as stirred vessels, stirred mills, Ultra-Turrax, in-line dissolvers, static mixers, toothed wheel dispersers, expansion nozzles and/or microfluidizers.

The resultant reactive compositions are prepared in suitable molds or are preferably poured into molds immediately following their preparation, the preparation and handling of the reactive compositions requiring no special precautionary measures.

The molds may comprise any materials preferably not attacked by water or by aqueous media or pervious to water. Examples of suitable materials are heat-stable substances, such as metals, glass, ceramic, natural minerals, concrete or cement, or comparatively thermolabile materials such as plastics, rubber, leather, wood, textiles or paper. It is preferred to use materials which are easy to remove from the resultant solids. Particular preference is given to using molds from which the solids can be removed without the molds being destroyed in the process. Examples of suitable such molds are trays, strips or troughs.

Subsequently, the reactive compositions are cured. Curing may be accelerated by means of elevated temperature, reduced atmospheric humidity, and/or actinic radiation such as near infrared, visible light, UV radiation or electron beams. Preferably, curing takes place without the additional measures and at room temperature.

The duration of curing may vary very widely and depending on the composition may amount to from 20 s to several days, especially from one to two days.

After curing, the resultant solids are released without problems from the molds.

Prior to further processing, the solids may be dried or they may be comminuted immediately.

Preferably they are first of all coarsely comminuted using the customary and known techniques and apparatus, such as chopping, using crushers, or machining. The coarsely comminuted solid is pulverized, for which the customary and known methods and apparatus such as hammer mills, ball mills, laboratory mills, and stirred mills may be employed. Subsequently, the resultant powders of the invention may also be classified in order to set advantageous particle size distributions.

The powders of the invention may be put to a very wide variety of uses: for example, as insulating materials, packaging materials, or additives to cement or concrete. Preferably, they are used as fillers in coating materials, adhesives, and sealing compounds.

The coating materials, adhesives, and sealing compounds of the invention which comprise the fillers of the invention may be cured physically, thermally, with actinic radiation, especially UV radiation, or both thermally and with actinic radiation. They may comprise one- or two-component or multicomponent systems, aqueous systems, conventional systems based on organic solvents, substantially water-free and solvent-free powders, powder suspensions (powder slurries), or substantially water-free and solvent-free liquid systems (100% systems). The fillers of the invention are therefore virtually unlimited in their usefulness in the field of coating materials, adhesives, and sealing compounds.

With very particular preference, the fillers of the invention are used in the coating materials based on copolymers (A) as known from the German patent applications DE 199 30 665 A1, DE 199 30 067 A1, and DE 199 30 664 A1.

Substrates which may be coated, bonded or sealed using the coating materials, adhesives, and sealing compounds of the invention include virtually all substrates undamaged by curing of the coating materials, adhesives, and sealing compounds present thereon using heat and/or actinic radiation. The substrates preferably comprise metals, plastics, wood, ceramic, stone, textile, fiber composites, leather, glass, glass fibers, glass wool and rock wool, mineral- and resin-bound building materials, such as plasterboard and cement slabs or roof tiles, and also composites of these materials.

The coating materials, adhesives, and sealing compounds of the invention are particularly appropriate for the coating, bonding, and sealing of motor vehicle bodies, of buildings inside and out, or of doors, windows, and furniture.

In the context of industrial coating, including coil coating, container coating, and the impregnation and/or coating of electrical components, they are outstandingly suitable for coating, bonding or sealing virtually all parts and articles for private or industrial use, such as white goods, including domestic appliances, boilers or radiators; small metal parts, including bolts, nuts, hubcaps or wheel rims; packaging, or electrical components, including motor windings or transformer windings.

The coatings produced from the coating materials of the invention have outstanding performance properties, in particular a very good resistance toward mechanical attack such as stone impact.

The adhesive films produced from the adhesives of the invention have a high bond strength, which is not lost even under extreme climatic conditions and/or on exposure to frequently changing temperatures.

The seals produced from the sealing compounds of the invention provide outstanding sealing of the resin substrates even in the presence of aggressive substances, and do so durably.

The substrates coated with coatings of the invention, bonded with adhesive films of the invention and/or sealed with seals of the invention therefore have numerous technical and economic advantages, in particular a long service life, which makes them particularly attractive for manufacturers and users.

### EXAMPLES

### Preparation Example 1

### The Pr paration of a Dispersion of a Copolymer (A)

A steel reactor as is commonly used for preparing dispersions, equipped with a stirrer, a reflux condenser and 3 feed vessels, was charged with 1 591.1 parts by weight of DI water and this initial charge was heated to 80° C. 308.2 parts by weight of acrylic acid, 555.2 parts by weight of methyl methacrylate and 45.2 parts by weight of diphenyl-ethylene were charged to the first feed vessel. 300.1 parts by weight of 25 percent strength ammonia solution were charged to the second feed vessel. 159 parts by weight of DI water and 68.2 parts by weight of ammonium peroxodisulfate were charged to the third feed vessel. With intensive stirring of the initial charge in the steel reactor, the three feeds were commenced simultaneously. The first and second feeds were metered in over the course of four hours. The third feed was metered in over the course of four and a half hours. The resultant reaction mixture was held at 90° C. for four hours and then cooled to below 40° C. and filtered through a 100 μm GAF bag. The resultant dispersion had a solids content of from 32 to 34% by weight (1 hour, 130° C.) and a free monomer content of less than 0.2% by weight (determined by gas chromatography).

The dispersion (A) was used to prepare the block copolymer (A).

### Preparation Example 2

### The Preparation of the Dispersion of a Block Copolymer (A)

A steel reactor as is commonly used for preparing dispersions, equipped with a stirrer, a reflux condenser and one feed vessel, was charged with 1 361.7 parts by weight of DI water and 240 parts by weight of the dispersion (A) from preparation example 1, and this initial charge was heated to 80° C. with stirring. Thereafter, a mixture of 103.6 parts by weight of n-butyl methacrylate, 103.6 parts by weight of styrene, 103.6 parts by weight of hydroxyethyl methacrylate and 725.6 parts by weight of 2-ethylhexyl methacrylate was metered in from the feed vessel over the course of six hours. The resultant reaction mixture was stirred at 90° C. for two hours. Subsequently, the resultant dispersion was cooled to below 40° C. and filtered through a 50 μm GAF bag. The dispersion (A) had a solids content of from 41 to 42% by weight (1 hour, 130° C.) and a free monomer content of less than 0.2% by weight (determined by gas chromatography).

### Example 1

### The Preparation of a Powder of the Invention

100 parts by weight of the dispersion (A) from preparation example 2 and 15 parts by weight of a customary melamine resin (Luwipal® 73 from BASF Aktien-gesellschaft) were mixed and homogenized with thorough stirring. The reactive composition was poured into flat trays in which it cured over the course of from 24 to 48 hours. The resultant solids were taken from the trays and comminuted, first coarsely and then more thoroughly in a hammer mill.

### Example 2

### The Preparation of a Pigment Paste Comprising a Filler of the Invention

To prepare the pigment paste of the invention, the following constituents were mixed and homogenized in the sequence stated:

670 parts by weight of a dispersion (A) from preparation example 2,

4.8 parts by weight of Agitan® 281 (defoamer from Munzing),

12 parts by weight of Additol® WW 395 (commercial leveling agent from Solutia),

72 parts by weight of the powder of the invention from example 1,

45.6 parts by weight of Flammruβ 101 (carbon black from Degussa), and

394.8 parts by weight of barium sulfate pigment (Blanc Fixe® Super F from Sachtleben Chemie).

The resultant pigment paste was ground in a ball mill to a Hegmann fineness of 10 μm. The pigment paste was stable on storage.

### Example 3

### The Preparation of a Filler Slurry of the Invention

506.6 parts by weight of the dispersion (A) from preparation example 2, 3.4 parts by weight of Agitan® 281 and 340 parts by weight of the powder of the invention from example 1 were mixed, and homogenized using a dissolver. The resultant slurry was ground in a bore mill to a Hegmann fineness of 10 μm. The slurry was stable on storage.

### Example 4

### The Preparation of a Pigmented Filler Slurry of the Invention

To prepare the pigmented filler slurry, the following constituents were mixed with one another and homogenized in the sequence stated:

562 parts by weight of the dispersion (A) from preparation example 2,

4.8 parts by weight of Agitan® 281,

12 parts by weight of Additol® XW395,

180 parts by weight of the filler slurry from example 3,

45.6 parts by weight of Flammruβ 101, and

394.8 parts by weight of barium sulfate pigment.

The mixture was ground in a bore mill to a Hegmann fineness of 10 μm. The pigmented filler slurry was stable on storage.

### Example 5

### The Preparation of a Paint

63 parts by weight of the pigment paste from example 2 comprising the filler of the invention, 92.6 parts by weight of the dispersion (A) from preparation example 2 and 15.5 parts by weight of the commercial additive Trixene® BI 7986 from Baxenden Chemicals were mixed with one another and homogenized. The paint of the invention was then adjusted to a pH of 8.3. The storage stability of the paint was outstanding. Before the paint was applied, the spray viscosity was set by adding water. The paint could be applied without any problem.

### Example 6

### The Preparation of a Paint

63 parts by weight of the pigmented filler slurry of the invention from example 4, 92.6 parts by weight of the dispersion (A) from preparation example 2 and 15.5 parts by weight of the commercial additive Trixene® BI 7986 from Baxenden Chemicals were mixed with one another and homogenized. The paint of the invention was then adjusted to a pH of 8.3. The storage stability of the paint was outstanding. Before the paint was applied, the spray viscosity was set by adding water. The paint could be applied without any problem.

### Examples 7 and 8

### The Production of Coating Systems of the Invention

Example 7 was carried out using the paint of the invention from example 5, and example 8 using the paint of the invention from example 6.

The paints were applied pneumatically to steel panels which have been coated with a cathodically deposited and baked electrodeposition coat, paint application taking place in a wet film thickness so as to give, after drying at 80° C. for 10 minutes and baking at 155° C. for 20 minutes, coating systems with a coat thickness of 33 μm (example 7) and 30 μm (example 8).

The stonechip resistance of the coating systems was determined by means of the MB ball shot test and the VDA [German automakers' association] stonechip test. The results obtained were as follows:

Example 7: MB ball shot (mm²): 2/1; VDA (rating): 1.5/1

Example 8: MB ball shot (mm²): 3/2; VDA (rating): 1.5/1

The results underline the good stonechip resistance of the coating systems of the invention. Moreover, the coating systems of the invention were of high optical quality, possessed very good leveling, high chemical resistance, weathering stability, hardness, and scratch resistance. Additionally, they exhibited outstanding adhesion to the electrodeposition coat.

What is claimed is:

1. The use of a copolymer (A) preparable by the single-stage or multistage free-radical copolymerization of
a) at least one olefinically unsaturated monomer and
b) at least one olefinically unsaturated monomer different than the olefinically unsaturated monomer (a) and of the general formula I
R¹R²C═CR³R⁴ (i)
in which the radicals R¹, R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals
in an aqueous or organic medium for preparing functional organic powders:

2. The use as claimed in claim 1, wherein at least one monomer (a) contains at least one functional group that is reactive toward amino resin.

3. A functional organic powder preparable
(I) by reacting
(A) at least one primary and/or secondary aqueous dispersion of at least one copolymer (A) preparable by single-stage or multistage free-radical copolymerization in an aqueous or organic medium of
a) at least one olefinically unsaturated monomer and
b) at least one olefinically unsaturated monomer different than the olefinically unsaturated monomer (a) and of the general formula I
R¹R²C═CR³R⁴ (I)
in which the radicals R¹, R², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals
(B) with at least one amino resin, and
(II) by subsequently comminuting the resultant solid.

4. The powder as claimed in claim 3, wherein the copolymer (A) is obtainable by
(I) subjecting at least one monomer (a) and at least one monomer (b) to free-radical polymerization in an aqueous medium, and then
(II) reacting the resultant reaction product with at least one further monomer (a) under free-radical conditions in the absence of a free-radical initiator.

5. The powder as claimed in claim 3 or 4, wherein at least one monomer (a) contains at least one functional group that is reactive toward amino resin.

6. The powder as claimed in any of claims 3 to 5, wherein the aryl radicals R¹, R², R³ and/or R⁴ of the compound (b) are phenyl or naphthyl radicals, especially phenyl radicals.

7. The powder as claimed in any of claims 3 to 6, wherein the substituents in the radicals R¹, R², R³ and/or R⁴ of the compound (b) are electron withdrawing or electron donating atoms or organic radicals, especially halogen atoms, nitrile, nitro, partly or fully halogenated alkyl, cycloalkyl, alkylcycloalkyl, cycloalkylalkyl, aryl, alkylaryl, cycloalkylaryl, arylalkyl and arylcycloalkyl radicals; aryloxy, alkyloxy and cycloalkyloxy radicals; arylthio, alkylthio and cycloalkylthio radicals; hydroxyl groups and/or primary, secondary and/or tertiary amino groups.

8. The powder as claimed in any of claims 3 to 7, further comprising at least one additive (C).

9. The powder as claimed in claim 8, comprising at least one pigment as additive (C).

10. The powder as claimed in claim 9, wherein the pigments (C) are selected from the group consisting of color and/or effect pigments, fluorescent pigments, electrically conductive pigments, and magnetically shielding pigments, metal powders, organic and inorganic, transparent and opaque fillers, and nanoparticles.

11. A process for preparing an organic functional powder as claimed in any of claims 3 to 10, which comprises
(I) preparing a reactive composition of matter comprising
(A) the aqueous dispersion of at least one copolymer (A) preparable by free-radical copolymerization in an aqueous or organic medium of
(a) at least one olefinically unsaturated monomer having at least one functional group which is reactive toward amino resin, and
(b) at least one olefinically unsaturated monomer different than the olefinically unsaturated monomer (a) and of the general formula I
R¹R²C═CR³R⁴ (I)
in which the radicals R¹, R ², R³ and R⁴, in each case independently of one another, are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals
and
(B) at least one amino resin,
(II) curing the reactive composition of matter to give a solid in an appropriate mold,
(III) separating mold from solid, and
(IV) comminuting the solid.

12. The use of the powder as claimed in any of claims 3 to 10 or of the powder prepared with the aid of the process as claimed in claim 11 as a filler.

13. The use as claimed in claim 12, wherein the filler is used in coating materials, adhesives, and sealing compounds.
